(19) United States
(12) Patent Application Publication
(10) Pub. No.: US 2026/0363258 A1
(43) Pub. Date: Nov. 19, 2026

(54) INGREDIENT FOR IMPROVING SHELF LIFE

(71) Applicant: FERMENTATIONEXPERTS A/S, Baekke (DK)

(72) Inventor: Jens Hoffner Legarth, Baekke (DK)

(73) Assignee: FERMENTATIONEXPERTS A/S, Baekke (DK)

(21) Appl. No.: 19/132,422

(22) PCT Filed: Nov. 24, 2023
(86) PCT No.: PCT/EP2023/083054

§ 371 Date: May 23, 2025

(30) Foreign Application Priority Data
Nov. 26, 2022 (DK) PA202201077

(51) Int. Cl. A23B 4/22; A23B 2/733; A23B 11/00

(52) U.S. Cl. CPC A23B 4/22; A23B 2/733; A23B 11/00

(57) ABSTRACT

The present invention relates to the use of an ingredient for improving the shelf life of a food product, wherein the food product comprising a basic food component and the ingredient, and the food product comprises within the range of 5-75% (w/w) of the ingredient and wherein the ingredient comprises a fermented vegetable material.

### TECHNICAL FIELD OF THE INVENTION

The present invention relates to a method for improving the shelf life of a product, in particular a food product for human consumption. In particular, the present invention relates to addition of an ingredient to a basic food composition for increasing the shelf life of a food product.

### BACKGROUND OF THE INVENTION

For products being highly perishable commodity shelf life becomes a race against the clock for growers, processors, retailers, and consumers. With national averages of product shrinkage at 6%, according to the Produce Marketing Association, shelf life costs US retailers alone in excess of $2.1 billion per year.

Shelf life is the period of time a food has before it is considered unsuitable for consumption or sale. The shelf life of different product can vary considerably depending on multiple factors.

U.S. generates more than 34 million tons of food waste each year costing around $1 billion every year just to dispose of all its food waste. This waste has significant impact financially and environmentally on individuals and businesses alike and these numbers are highly affected by the shortened shelf life of the products affecting growers, processors, retailers and ultimately the consumer's bottom line.

Financial loss coupled with today's lengthening of food transport is every food handling institution's motivation for considering new technologies that extend shelf live. From the moment a product is harvested, or an animal is slaughtered the clock starts ticking and product decay begins. The main factors that affect shelf life of food products may include improper handling, inadequate humidity, temperature abuse and Ethylene exposure.

One of the most considered factor when extending shelf life of a food product is temperature and preserving food products using reduced temperatures has been utilized for over 100 years. Storing food products in cold temperatures protects the food product from decay and bacteria. This extensions of the shelf life in turn also extends the food product's selling period.

Transporting and storing food products at low temperatures slows the aging and decay of food product as well minimizes the chances of food products to be affected by bacteria, yeast and molds.

In addition to the factors affecting decay and shelf life of food products, chemical methods of food preservation may be used for keeping food safe to eat.

There are a variety of chemical methods of food preservation, where salting (including nitrates and nitrites sodium benzoate, and sulphites), sugaring, and smoking are commonly described however, these methods strongly affect the taste of the food product or may have negative environmental effects and may be avoided in many applications.

Some of the chemical preservatives that are allowed to use in food may include benzoic acid, propionic acid, sorbic acid, sodium nitrite, potassium sulphite, however, some food producers also use preservatives that are prohibited for use in food and harmful to health in order to provide sufficient shelf life to the food product.

Hence, shelf life of food products has become increasingly important, but at the same time difficult to achieve, because of the increasing demands for food product, because of today's lengthening transportation and because of the long (and time consuming) way from harvest/slaughter to the retailers and to the consumers

Hence, there is a need in the industry for method of increasing the shelf life of a food product, and in particular a more efficient and/or reliable method for increasing the shelf life of a food product which may reduce the amount of waste food, impose a positive CO₂ imprint on the environment, with no or limited effect on taste, flavour and odour, and without the side effects of the traditional preservation methods would be advantageous.

### SUMMARY OF THE INVENTION

Thus, an object of the present invention relates to a method for improving the shelf life of a product, in particular a food product for human consumption. In particular, the present invention relates to addition of an ingredient to a basic food composition for increasing the shelf life of a food product.

In particular, it is an object of the present invention to provide a method that solves the above mentioned problems of the prior art with waste food, and effects on taste, flavour and odour

Thus, one aspect of the invention relates to the use of an ingredient for improving the shelf life of a food product, wherein the food product comprising a basic food component and the ingredient, and the food product comprises within the range of 5-75% (w/w) of the ingredient and wherein the ingredient comprises a fermented vegetable material.

Another aspect of the present invention relates to a food product comprising an improved shelf life, wherein the food product comprising a basic food component and an ingredient, and wherein the food product comprises in the range of 5-75% (w/w) of the ingredient and wherein the ingredient comprises a fermented vegetable material.

Yet another aspect of the present invention relates to a food product comprising an improved shelf life, the food product comprising a basic food component-, and an ingredient, wherein the food product comprises in the range of 5-75% (w/w) of the ingredient and wherein the ingredient comprises a fermented vegetable material, and wherein the food product is selected from a meat product, a seafood product, a dairy product, or a combination hereof.

A further aspect of the present invention relates to a packaging comprising an ingredient for improving the shelf life of a food product, wherein the ingredient comprises a fermented vegetable material.

Still another aspect of the present invention relates to a method for providing a food product comprising an improved shelf life, the method comprises the steps of:
(i) Providing an ingredient comprising a fermented vegetable material;
(ii) Combining the fermented vegetable material with a basic food component, providing a mixed basic food component;
(iii) Preparing the mixed basic food component providing the food product.

The present invention will now be described in more detail in the following.

### DETAILED DESCRIPTION OF THE INVENTION

Accordingly, the inventor of the present invention surprisingly found that the shelf life of a food product may be significantly improved by adding an ingredient according to the present invention to a basic food component.

A preferred embodiment of the present invention relates to the use of an ingredient for improving the shelf life of a food product, wherein the food product comprising a basic food component and the ingredient, and the food product comprises within the range of 5-75% (w/w) of the ingredient and wherein the ingredient comprises a fermented vegetable material.

The basic food component may be a meat product, a vegetable food product or a cereal product, a dairy product, a seafood product, or a combination hereof.

Preferably, the basic food component may be a meat product, a vegetable food product, a dairy product, a seafood product, or a combination hereof. Even more preferably, the basic food component may be a meat product, a vegetable food product, a dairy product, or a combination hereof. Even more preferably, the basic food component may be a meat product, a vegetable food product, or a combination hereof. Even more preferably, the basic food component may be a meat product.

In an embodiment of the present invention the fermented vegetable material may be fermented using one or more lactic acid-producing microorganism.

Preferably, the fermentation of the vegetable material may not include a yeast fermentation of the vegetable material.

In an embodiment of the present invention the shelf life of the food product may be improved by at least 1.25 times relative to the shelf life obtained from a food product without the fermented vegetable product, such as by at least 1.5 time, e.g. by at least 1.75 times, such as by at least 2.0 time, e.g. by at least 2.25 times, such as by at least 2.5 time, e.g. by at least 2.75 times, such as by at least 3.0 time, e.g. by at least 3.25 times, such as by at least 3.5 time, e.g. by at least 3.75 times, such as by at least 4 times.

A preferred embodiment of the present invention relates to a food product comprising an improved shelf life, wherein the food product comprising a basic food component and an ingredient, and wherein the food product comprises in the range of 5-75% (w/w) of the ingredient and wherein the ingredient comprises a fermented vegetable material.

In an embodiment of the present invention the improved shelf life of may be obtained at an elevated temperature relative to the shelf life of a corresponding food product at a refrigerated temperature.

Preferably, the elevated temperature may be a temperature in the range of 10-45 °C, such as in the range of 15-40 °C, e.g. in the range of 17-35 °C, such as in the range of 18-30 °C, e.g. in the range of 19-28 °C, such as in the range of 20-25 °C, e.g. at about 22 °C.

The refrigerated temperature may be a temperature in the range of 1-6 °C, such as in the range of 3-5 °C, e.g. at about 4 °C.

A preferred embodiment of the present invention relates to a food product comprising an improved shelf life, the food product comprising a basic food component and an ingredient, wherein the food product comprises in the range of 5-75% (w/w) of the ingredient and wherein the ingredient comprises a fermented vegetable material, and wherein the food product may be selected from a meat product, a seafood product, a dairy product, or a combination hereof. Preferably, the food product may be a meat product.

In an embodiment of the present invention the fermented vegetable material may be fermented before being added to the food product providing the food product.

The present invention relates to a method for providing a food product comprising an improved shelf life, the method comprises the steps of:
(i) Providing an ingredient comprising a fermented vegetable material;
(ii) Combining the fermented vegetable material with a basic food component, providing a mixed basic food component;
(iii) Preparing the mixed basic food component providing the food product.

Preferably, the ingredient provided in step (i) may be an ingredient according to the present invention.

The step of preparing the mixed basic food component may include baking, cooking, curing, smoking, posteriorizing, preserving, packaging or a combination hereof.

In an embodiment of the present invention the content of ingredient (fermented vegetable material) in the food product may be in the range of 5-75% (w/w), e.g. in the range of 6-60% (w/w), such as in the range of 7-50% (w/w), e.g. in the range of 8-40% (w/w), such as in the range of 9-30% (w/w), e.g. in the range of 10-25% (w/w), such as in the range of 12-20% (w/w), e.g. in the range of 14-18% (w/w), such as in the range of 5-40% (w/w), e.g. in the range of 6-30% (w/w), such as in the range of 7-20% (w/w), e.g. in the range of 8-10% (w/w).

The food product may comprise a basic food component selected from a meat product, a dairy product, a cereal product, a vegetable product, a seafood product, or a combination hereof.

Preferably, the food product may comprise a basic food component selected from a meat product, a dairy product, a seafood product, or a combination hereof. Even more preferably, the basic food component may be a meat product.

The basic food component may comprise a meat product. The meat product may be selected from cow meat product, cattle meat product, lamb meat product, sheep meat product, goat meat product, poultry meat product, pig meat product, deer meat product, or a combination hereof.

The basic food component may comprise a vegetable basic food product. The vegetable basis food product may be peas, chickpeas, cabbage, or a combination hereof.

The basic food component may comprise a dairy product. The dairy product may be an infant formula, a yoghurt, a butter, or a cheese, or a combination hereof.

The basic food component may comprise a cereal product. Preferably, the cereal product may be a fermented cereal product, such as a yeast fermented cereal product. In an embodiment of the present invention the cereal product may be bread, such as a white bread or a rye bread.

The basic food component may comprise a seafood product, the seafood product may comprise cod, salmon, tuna, pollock, menhaden, sardine, anchovies, herring capelin, blue whiting, mackerel, pout, sprat, sperling and/or sand eel.

In an embodiment of the present invention the basic food component may comprise a chopped or ground meat product, a dairy product, a cereal product, or a vegetable product, a seafood product, or a combination hereof.

In an embodiment of the present invention the food product may be a pate or terrine, or a sausage, a bread (white bread or ray bread), hummus, a chopped or ground meat product, a chopped or ground seafood product, a chopped or ground vegetable product.

The food product may comprise between 25-95% (w/w) basic food component, such as in the range of 40-94% (w/w), e.g. in the range of 50-93% (w/w), such as in the range of 60-92% (w/w), e.g. in the range of 70-91% (w/w), such as in the range of 75-90% (w/w), e.g. 80-88% (w/w). The basic food component may be selected from a meat product, a dairy product, a cereal product, or a vegetable product, a seafood product, or a combination hereof.

Preferably, the food product may be a fresh food product. Preferably, the food product may not be a frozen food product.

The food product may preferably be stored at a temperature of 1-45 °C, such as a temperature in the range of 2-40 °C, e.g. in the range of 3-35 °C, such as in the range of 4-30 °C, e.g. in the range of 5-25 °C.

In an embodiment of the present invention the improved shelf life may be obtained at temperatures in the temperature range of 3-35 °C, such as in the range of 4-30 °C,

Preferably, the ingredient consists essentially of a fermented vegetable material.

The ingredient according to the present invention may consist essentially of a vegetable material and one or more lactic acid-producing microorganism, even more preferably, the ingredient according to the present invention may consist essentially of a vegetable material and one or more lactic acid-producing bacteria.

The presence of one or more lactic acid-producing microorganism together with the vegetable material to be fermented, may preferably relate to a vegetable material to be fermented which may not be subjected to yeast fermentation and/or to enzymatic hydrolysis.

In the context of the present invention the term “consisting essentially of” or “consists essentially of” relates to the presence of amounts of other components in addition to the mandatory and defined components, and wherein the presence of the other components provided does not materially affect the essential characteristics of the ingredient.

The ingredient may not include a cereal material.

In an embodiment of the present invention the ingredient does not comprise a seaweed or an algae.

Preferably, the ingredient does not comprise a marine mollusc.

Preferably, the ingredient does not comprise a vegetable material to be fermented which may have been subjected to enzymatic treatment.

In an embodiment of the present invention the improved shelf life may preferably be an improved shelf life relative to the shelf life of a corresponding food product without the fermented vegetable product.

Generally, the shelf life of food may be the period during which a food product retains an acceptable quality from a safety and organoleptic point of view, and may depend on four main factors, (1) the formulation, (2) the processing, (3) the packaging and (4) the storage conditions.

The term “shelf life” according to the present invention relates to the formulation of the food product where an ingredient according to the present invention has been added.

In an embodiment of the present invention the shelf life may be defined by microbial development, in particular bacterial formation, fungal formation and/or mold formation, preferably bacterial formation and/or mold formation, on the food product. Preferably the microbial development, in particular bacterial formation, fungal formation and/or mold formation, preferably bacterial formation and/or mold formation, may be visual microbial development, in particular bacterial formation, fungal formation and/or mold formation, preferably visual bacterial formation and/or mold formation, on the food product.

The shelf life of the food product according to the present invention (as well as a similar food product without the addition of the ingredient according to the present invention) may be further improved known methods of improving processing, packaging and storage conditions of the food products.

In an embodiment of the present invention the improved shelf life may be an improved shelf life at an elevated temperature relative to the shelf life of a corresponding food product without the fermented vegetable product.

The shelf life of the food product according to the present invention may be improved by at least 1.25 times relative to the shelf life of a food product without the fermented vegetable product when both products are stored under same conditions (either both products are stored at refrigerated temperatures or both products are stored at elevated temperatures), such as by at least 1.5 time, e.g. by at least 1.75 times, such as by at least 2.0 time, e.g. by at least 2.25 times, such as by at least 2.5 time, e.g. by at least 2.75 times, such as by at least 3.0 time, e.g. by at least 3.25 times, such as by at least 3.5 time, e.g. by at least 3.75 times, such as by at least 4 times.

In an embodiment of the present invention the improved shelf life may be an improved shelf life at an elevated temperature relative to the shelf life of a corresponding food product without the fermented vegetable product at a refrigerated temperature.

The shelf life of the food product according to the present invention may be improved by at least 1.25 times when stored at elevated temperatures relative to the shelf life of a food product without the fermented vegetable product stored at refrigerated temperatures, such as by at least 1.5 time, e.g. by at least 1.75 times, such as by at least 2.0 time, e.g. by at least 2.25 times, such as by at least 2.5 time, e.g. by at least 2.75 times, such as by at least 3.0 time.

The food product according to the present invention may be subjected to preservation.

Preservation according to the present invention may be implemented in two modes, a chemical preservation, a physical preservation or a combination of the chemical preservation and the physical preservation. Chemical preservation may entail adding chemical compounds to the food product. Physical preservation may entail processes such as refrigeration or drying.

Chemical preservation may reduce the risk of foodborne infections, decrease microbial spoilage, and preserve fresh attributes and nutritional quality. Some physical techniques for food preservation may include dehydration, UV-C radiation, freeze-drying, and refrigeration.

The effect of the preservation used may be highly dependent on the food product and/or the basic food component as the effect of the preservation is highly dependent on the interaction between the preservation (chemical preservation and/or physical preservation) and the food product and/or the basic food component.

In an embodiment of the present invention the food product may have a moisture content in the range of 10-75% (w/w).

The moisture content of the food product may be at least 10% (w/w), such as at least 15% (w/w), e.g. at least 20% (w/w), such as at least 25% (w/w), e.g. at least 30% (w/w), such as at least 35% (w/w), e.g. at least 40% (w/w), such as at least 45% (w/w), e.g. at least 50% (w/w), such as at least 55% (w/w), e.g. at least 60% (w/w), such as in the range of 10-75% (w/w), e.g. in the range of 15-70% (w/w), such as in the range of 20-65% (w/w), e.g. in the range of 25-60% (w/w), such as in the range of 30-55% (w/w), e.g. in the range of 35-50% (w/w), such as in the range of 40-45% (w/w).

The vegetable material may be a protein-rich vegetable material. Preferably, the protein-rich vegetable material may comprise a protein content above 15% (w/w), such as above 16% (w/w), e.g. above 17% (w/w), such as above 18% (w/w), e.g. above 19% (w/w), such as above 20% (w/w), e.g. above 21% (w/w), such as above 22% (w/w), e.g. above 23% (w/w), such as above 24% (w/w), e.g. above 25% (w/w).

The vegetable material may be selected from a protein-rich vegetable material. Preferably, the protein-rich vegetable material may be selected from a Brassicaceae family or a Fabaceae family.

Preferably the vegetable material according to the present invention may be selected from Brassicale plants, Fabales plants and/or root vegetables.

In an embodiment of the present invention the Brassicale plants may be selected from the Brassicaceae family or the Cruciferae family.

In a further embodiment of the present invention, the Brassicaceae family or the Cruciferae family may be selected from at least one of a Brassica species; sunflower; palm; soya, field beans, lupins; or a combination hereof. Preferably, at least one Brassica species may be selected from one or more species such as Brassica napus; Brassica oleracea; Brassica campestris; Brassica nigra; Sinapis alba (Brassica alba); Brassica juncea; Brassica rapa or mixtures hereof.

In yet an embodiment of the present invention, the at least one Brassica species may be selected from the group consisting of: including rape, rapeseed, canola, cabbage, broccoli, cauliflower, kale, Brussels sprouts, collard greens, savoy, kohlrabi, gai Ian, white mustard, Indian mustard, Chinese mustard, and black mustard seed powder.

In an embodiment of the present invention the Fabales plants may be selected from Fabaceae or Leguminosae, such as the legume, the pea, or the bean family.

In yet an embodiment of the present invention the Fabales plants may be selected from soybean (glycine max); pea; and/or Vicia faba.

The rosid plants may preferably be selected from the Malvaceae family and in particular the tripe Gossypieae.

In an embodiment of the present invention the vegetable material may be selected from the nightshade family, the Solanaceae family, or the Euphorbiaceae family. In particular Solanaceae family may be selected from the genus solanum, and specifically from the species S. tuberosum) and/or a malpighiale plant (in particular, malpighiale plant may be selected from the euphorbiaceae family, in particular from the genus manihot, and specifically from the species M. esculenta). In an embodiment of the present invention the root vegetable may be selected from potato meal; potato protein concentrate; and/or potato flakes.

The terms “nightshade family” and “Solanaceae family” may be used interchangeably and relates to the same family of plant materials and comprise a family of flowering plants that ranges from annual and perennial herbs to vines, lianas, epiphytes, shrubs, and trees.

The Solanaceae family may include plants selected from agricultural crops, medicinal plants, spices, weeds, and ornamentals.

The Solanaceae family may preferably be selected from the group of plant materials selected from the genus Solanum; or the Capsicum family. Preferably, the plant materials may be selected from the genus Solanum.

In an embodiment of the present invention the plant materials selected from the genus Solanum may be selected from potato, like S. tuberosum; tomatoes, like S. lycopersicum; or egg plants, like Solanum melongena. Preferably, the plant materials selected from the genus Solanum may be potato, like S. tuberosum.

In yet an embodiment of the present invention the plant materials selected from the genus Manihot may be selected from bell peppers, like Capsicum annuum; or chili pepper, like C. chinense or C. frutescens.

The Euphorbiaceae family may preferably be selected from the group of plant materials selected from the genus Manihot, in particular, cassava, like M. esculenta.

In a preferred embodiment of the present invention the vegetable material may be selected from Brassica species. Preferably, at least one Brassica species may be selected from one or more species such as Brassica napus; Brassica oleracea; Brassica campestris; Brassica nigra; Sinapis alba (Brassica alba); Brassica juncea; Brassica rapa or mixtures hereof.

In an embodiment the brassica species comprises a seed product in the form of a seed product and/or a cake product, such as a rapeseed product, like a rapeseed meal or a rapeseed cake, preferably rapeseed cake.

In a preferred embodiment of the present invention the fermented vegetable material may be provided by subjecting a basic food component to a fermentation using a lactic acid-producing microorganism.

Preferably, the fermentation according to the present invention may consist essentially of a lactic acid-producing microorganism fermentation.

In a preferred embodiment of the present invention the lactic acid-producing microorganism or the one or more lactic acid-producing microorganism may be one or more lactic acid-producing bacteria.

The fermentation according to the present invention may consist essentially of a bacterial fermentation, preferably a lactic acid-producing bacteria fermentation.

The one or more lactic acid-producing bacteria may be selected from a strain selected from the group consisting of the genus Enterococcus, Lactobacillus, Pediococcus, Lactococcus, or Bifidobacterium or combinations thereof.

In a further embodiment of the present invention the one or more lactic acid-producing bacteria may be selected from the group consisting of Pediococcus pentosaceus; Pediococcus acidilactici; Lactobacillus plantarum, Lactobacillus rhamnosus, Enterococcus faecium, Lactobacillus acidophilus, Bifidobacterium lactis, Bifidobacterium longum, Bifidobacterium bifidum, Lactobacillus salivarius, Lactobacillus pentoses, Lactobacillus vaginalis, Lactobacillus xylosus and a combination thereof.

During fermentation a group of microorganisms may be used for fermenting the starting material (the starting vegetable material) to provide a co-fermentation. The co-fermentation may be a mixture of different microorganisms (such as a mixture of fungus, and/or bacteria) or a mixture of different bacteria. Preferably the co-fermentation comprises a mixture of different bacterial strains.

In an embodiment of the present invention the ingredient comprises one or more bacterial strains, e.g. two or more bacterial strains, such as three or more bacterial strains, e.g. four or more bacterial strains, such as 7 or more bacterial strains, e.g. 10 or more bacterial strains, such as 15 or more bacterial strains, e.g. 20 or more bacterial strains, such as 25 or more bacterial strains, e.g. 30 or more bacterial strains, such as 35 or more bacterial strains, e.g. 40 or more bacterial strains. Preferably, the bacterial strains may be one or more lactic acid bacterial strains.

In a further embodiment of the present invention the one or more lactic acid-producing bacteria may be selected from the group consisting of one or more of Enterococcus faecium MCIMB 30122, Lactobacillus rhamnosus NCIMB 30121, Pediococcus pentosaceus HTS (LMG P-22549), Pendiococcus acidilactici NCIMB 30086 and/or Lactobacillus plantarum LSI (NCIMB 30083).

Preferably, the fermented vegetable material may not be subjected to a yeast fermentation before being combined with the basic food component.

In an embodiment of the present invention the food product comprising the ingredient (or the ingredient before being added to the basic food component) does not comprise viable lactic acid-producing microorganisms, preferably not comprising lactic acid-producing microorganisms originating from the food ingredient.

Preferably, the ingredient according to the present invention and/or the food product according to the present invention comprises no viable lactic acid-producing microorganisms.

The viability of the lactic acid-producing microorganisms (The strains are dead, inactive, lysed, homogenised).

Thus, the effect in preserving the food product may lie in the metabolites produced and not in the activity of the bacteria.

Without being bound by theory, it is believed that the improved shelf life obtained is not caused by a reduction in pH, since the ingredient is does not reduce the pH of the food product or the basic food component significantly.

In an embodiment of the present invention the pH value of the food product according to the present invention is pH 4.0 or above, such as pH 4.5 or above, e.g. pH 5.0 or above, such as pH 5.5 or above, e.g. pH 6.0 or above, such as pH 6.5 or above, e.g. pH 7.0 or above, such as in the range of pH 4.0-9.0, e.g. in the range of pH 4.5-8.5, such as in the range of pH 5.0-8.0, e.g. in the range of pH 5.5-7.5, such as in the range of pH 6.0-7.0.

Preferably, the food ingredient may be added to the food product in an amount that does not affect the taste, flavour, odour, and or organoleptic properties of the food product.

In an embodiment of the present invention, the amount of food ingredient (fermented plant material) to be added without affecting the taste, flavour and/or odour of the food product may be in the range of 5-40% (w/w), e.g. in the range of 6-30% (w/w), such as in the range of 7-20% (w/w), e.g. in the range of 8-10% (w/w).

In a further embodiment of the present invention the ingredient according to the present invention has not may be subjected to isolation of one or more metabolites. Preferably, the isolation process does not involve concentration of the metabolites, e.g. by removal of water.

Preferably, the ingredient according to the present invention may comprise a fibrous material. Preferably, the fibrous material may be obtained from the fermented material i.e. the fermented vegetable material.

In an embodiment of the present invention the fibrous material present in the vegetable material fermented may preferably be maintained or substantially maintained in the ingredient and/or in the food product.

In the present context the term “substantially maintained” relates to maintaining at least 25% (w/w) of the fibrous material; such as at least 50% (w/w); e.g. at least 75% (w/w); such as at least 90% (w/w); e.g. at least 95% (w/w); such as at least 98% (w/w); e.g. at least 99% (w/w).

In an embodiment of the present invention the ingredient may comprise more than 5 g fibrous material originating from the starting material per kg food product, such as more than 10 g fibrous material per kg, e.g. more than 15 g fibrous material per kg, such as more than 20 g fibrous material per kg, e.g. more than 25 g fibrous material per kg, such as more than 50 g fibrous material per kg, e.g. more than 75 g fibrous material per kg, such as more than 100 g fibrous material per kg, e.g. more than 150 g fibrous material per kg, such as more than 200 g fibrous material per kg, e.g. more than 250 g fibrous material per kg, such as more than 300 g fibrous material per kg.

In an embodiment of the present invention the ingredient may be provided from a starting material, preferably the starting material may be a vegetable starting material, and a fermenting microorganism, in particular one or more lactic acid-producing microorganism.

After a sufficient fermentation of the starting material, the ingredient according to the present invention may be provided.

In an embodiment of the present invention the ingredient may comprise viable lactic acid-producing microorganisms. In a further embodiment, of the present invention the lactic acid-producing microorganism present in the ingredient may be in the form of a viable lactic acid-producing microorganism.

The term “viable” as used herein relates to a microorganism which is not dead and are able to have an active metabolism.

In an embodiment of the present invention the lactic acid-producing microorganisms present in the ingredient may be in the form of a viable lactic acid-producing microorganism.

The term “non-viable” as used herein relates to a microorganism which is dead and are unable to have an active metabolism.

The present invention relates to a process for preparing an ingredient (or a fermented vegetable material) according to the present invention, the method comprises the steps of:
(a) providing a starting material, in particular a starting vegetable material;
(b) providing an inoculum comprising one or more lactic acid-producing microorganism, in particular one or more lactic acid-producing bacteria;
(c) subjecting the starting material provided in step (a) to a fermentation process by combining the plant material provided in step a) with the inoculum provided in step (ii) providing the ingredient (or the fermented vegetable material).

The starting material, i.e. the vegetable starting material, may be fractionized by grinding, cutting, chopping, slicing, and/or fractionizing providing a fractionized starting material.

The starting material and/or the ingredient according to the present invention may comprise a fractionized vegetable material having an average diameter of 5 mm or less, such as an average diameter of 4 mm or less, such as an average diameter of 3 mm or less, such as an average diameter of 2 mm or less, such as an average diameter of 1 mm or less, such as an average diameter in the range 25 μm to 5 mm, such as 0.1 mm to 4 mm, such as an average diameter in the range of 0.5 mm to 2.5 mm, such as an average diameter in the range 0.5 mm to 2 mm.

Preferably, the fermentation process may be allowed to continue until the ingredient (or the fermented vegetable material) provided has a pH value below 5.5, such as a pH below 5.0, e.g. below pH 4.5, such as a pH below 4.2, e.g. below pH 4.0, such as a pH below 3.9, e.g. below pH 3.8.

Preferably, the inoculum consisting essentially of one or more lactic acid-producing microorganism. Even more preferably, the inoculum consisting essentially of one or more lactic acid-producing bacteria.

The inoculum according to the present invention may be a in a liquid form, dry form, or essentially dry form. The moisture content of the inoculum may be adjusted in order to optimize the fermentation process.

In one embodiment the inoculum may be provided as essentially pure and viable lactic acid-producing microorganisms (such as lactic acid-producing microorganisms in freeze dried form) or bacteria suspended in a suitable media prior to the application (such as a water, buffer or a growth media).

In an embodiment of the present invention the starting material, e.g. the starting vegetable material may be sterilized before addition of the at least one lactic acid-producing microorganisms to remove microorganisms and/or virus naturally present in the starting material (starting vegetable material).

Alternatively, an inoculum may be provided with a concentration of lactic acid-producing microorganisms in the inoculum sufficient to outgrow other (non-lactic acid bacteria, yeast or moulds present in the starting material. Accordingly, in one embodiment of the invention, the proportion of the inoculums in the combination of the starting material and inoculum may be in the range of 0.1 to 99.9 vol-%; such as 1 to 99 vol-%; e.g. 5 to 70 vol-%; such as 10 to 50 vol-%; e.g. 25 to 35 vol-%; such as 0.1 to 10 vol-%; e.g. 0.5 to 5 vol-%; such as 1 to 2.5 vol-%; or around 1 to 2 vol-%.

In order to provide the desired effects, the starting material should be provided with a high content of viable lactic acid-producing microorganisms. In an embodiment of the present invention the starting material comprises one or more lactic acid-producing microorganisms in a total amount in the range of 10⁵-10¹² CFU per gram starting material, such as in the range of 10⁶-10¹¹ CFU per gram, e.g. in the range of 10⁷-10¹⁰ CFU per gram, such as in the range of 10⁸-10⁹ CFU per gram, e.g. in the range of 10⁹-10¹⁰ CFU per gram.

The fermentation process provided by the present invention may preferably be an essentially homofermentative process. “Essentially homofermentative” means, that the predominant bacterial flora driving the fermentation process may be a homofermentative process, in particular a homolactic fermentative process.

In an embodiment of the present invention the fermented vegetable material or the ingredient comprises a content of lactic acid of at least 0.05 wt % lactic acid relative to the fermented material, such as at least 0.1% lactic acid, such as at least 0.5% lactic acid, e.g. at least 0.75% lactic acid, such as at least 1% lactic acid, e.g. at least 2.5% lactic acid, such as at least 5% lactic acid, e.g. at least 6% lactic acid, such as at least 7.5% lactic acid, such as in the range of 0.05-7.5% lactic acid relative to the fermented material, such as in the range of 0.1-6% lactic acid, such as in the range of 0.25-5% lactic acid, such as in the range of 0.5-2.5% lactic acid, such as in the range of 0.75-1% lactic acid.

The ingredient or the fermented vegetable material according to the present invention may comprise a lactic acid concentration of at least 25 mM, e.g. at least 50 mM, such as at least 100 mM, such as 100-1000 mM, such as 100-500 mM, such as 100-300 mM, such as 100-200 mM, such as 150-500 mM, such as 200-500 mM or such as 300-500, mM lactic acid.

“Essentially homofermentative” indicates also that the major fermentation product is lactic acid, and the levels of acetic acid and/or ethanol may be either below taste threshold, around taste threshold or slightly above taste threshold.

The ingredient and/or the fermented vegetable material according to the present invention comprises a content of acetic acid and/or ethanol of at most 100 mM; such as at most 50 mM; e.g. at most 25 mM; such as at most 10 mM; e.g. at most 1 mM; such as at most 0.1 mM; e.g. at most 0.01 mM; such as in the range of 0.01-100 mM; such as in the range of 0.1-75 mM; such as in the range of 1-50 mM; such as in the range of 5-25 mM; such as in the range of 1-10 mM.

Alternatively, “essentially homofermentative” may indicate a ratio of lactic acid to acetic acid or lactic acid to ethanol (mM/mM) of 10:1 or more, 20:1 or more, 50:1 or more, or 100:1 or more, 250:1 or more, or 500:1, 750:1 or more, or 1000:1 or more.

In an embodiment of the present invention the fermentation process may be a solid state fermentation.

Preferably, the fermentation process may be performed at a moisture content in the range 25-60%, such as 30-50%, such as 30-50%, such as 30-40%, such as 40-60% or such as 50-60%.

In an embodiment of the present invention the the fermentation process may be allowed to continue for a period of at least 12 hours, e.g. for at least 24 hours, such as for at least 48 hours, e.g. for at least 72 hours, such as for at least 4 days, e.g. for at least 5 days, such as for at least 6 days, e.g. for at least 7 days, such as for at least 8 days, e.g. for at least 9 days, such as for at least 10 days, e.g. for at least 11 days, such as for at least 12 days, e.g. for at least 15 days, such as for at least 20 days.

In yet an embodiment of the present invention the fermentation process may be allowed to continue for a period in the range of 12 hours to 40 days, e.g. for a period in the range of 24 hours to 30 days, such as for a period in the range of 2-25 days, e.g. for a period in the range of 5-20 days, such as for a period in the range of 7-15 days, e.g. for a period in the range of 10-13 days, e.g. about 11 days.

In a further embodiment of the present invention the fermentation process may be performed at a temperature in the range of 15-45 °C, such as 15-40 °C, such as 25-35 °C, such as 30-40 °C, such as 15-20 °C or such as 40-45 °C.

The moisture content of the starting material during the fermentation process may preferably be in the range of 20-65% (w/w) moisture; such as in the range of 30-55% (w/w) moisture; e.g. in the range of 35-45% (w/w) moisture; such as about 40% (w/w) moisture.

In a preferred embodiment of the present invention, the food product may be a pate.

In an embodiment of the present invention wherein the pate may be a meat pate, a vegetable pate, or a combination hereof.

The meat pate may be a pig pate, a poultry pate (in particular a chicken pate, duck pate, or a turkey pate), or a ruminant pate (in particular a beef pate). In particular the pate may be a pig pate, a poultry pate (in particular a chicken pate, duck pate, or a turkey pate), or a combination hereof.

In an embodiment of the present invention the pate may be a pig pate which may have a shelf life of at least 10 days, such as at least 15 days, e.g. at least 18 days, such as at least 20 days, e.g. at least 22 days, such as at least 25 days, e.g. at least 27 days, such as at least 30 days.

The shelf life of the pig pate may be improved by at least 1.25 times relative to the shelf life obtained from a pig pate without the fermented vegetable product (the ingredient), such as by at least 1.5 time, e.g. by at least 1.75 times, such as by at least 2.0 time, e.g. by at least 2.25 times, such as by at least 2.5 time, e.g. by at least 2.75 times, such as by at least 3.0 time, e.g. by at least 3.25 times, such as by at least 3.5 time, e.g. by at least 3.75 times, such as by at least 4 times.

In another embodiment of the present invention the pate may be a poultry pate, in particular a chicken pate, which may have a shelf life of at least 3 days, such as at least 5 days, e.g. at least 6 days, such as at least 8 days, e.g. at least 10 days, such as at least 15 days, e.g. at least 20 days, such as at least 25 days.

The shelf life of the poultry pate, in particular a chicken pate, may be improved by at least 1.25 times relative to the shelf life obtained from a poultry pate, in particular a chicken pate, without the fermented vegetable product (the ingredient), such as by at least 1.5 time, e.g. by at least 1.75 times, such as by at least 2.0 time, e.g. by at least 2.25 times, such as by at least 2.5 time, e.g. by at least 2.75 times, such as by at least 3.0 time, e.g. by at least 3.25 times, such as by at least 3.5 time, e.g. by at least 3.75 times, such as by at least 4 times.

A pate may include a paste, pie or loaf filled with meat or a forcemeat. Pate may often be served on or with bread or crackers. The pate may include:
ground meat from pork, poultry, fish, beef, or a combination hereof;
fat,
vegetables,
herbs,
spices and
optionally, either wine or brandy (often cognac or armagnac).

In a preferred embodiment of the present invention, the food product may be a sausage or a salami.

The salami may relate to a cured sausage. In the present context the terms “sausage” and “salami” may be used interchangeable.

In an embodiment of the present invention wherein the sausage may be a meat sausage or a vegetable sausage, or a combination hereof.

The meat sausage may be a pig sausage, a poultry sausage (in particular, a chicken sausage, duck sausage, or a turkey sausage), or a ruminant sausage (in particular, a beef sausage). In particular, the pate may be a pig sausage, a poultry sausage (in particular, a chicken sausage, duck sausage, or a turkey sausage), or a combination hereof.

In an embodiment of the present invention the sausage may be a pig sausage which may have a shelf life of at least 10 days, such as at least 15 days, e.g. at least 18 days, such as at least 20 days, e.g. at least 22 days, such as at least 25 days, e.g. at least 27 days, such as at least 30 days.

The shelf life of the pig sausage may be improved by at least 1.25 times relative to the shelf life obtained from a pig sausage without the fermented vegetable product (the ingredient), such as by at least 1.5 time, e.g. by at least 1.75 times, such as by at least 2.0 time, e.g. by at least 2.25 times, such as by at least 2.5 time, e.g. by at least 2.75 times, such as by at least 3.0 time, e.g. by at least 3.25 times, such as by at least 3.5 time, e.g. by at least 3.75 times, such as by at least 4 times.

A sausage may be a cured sausage, a raw sausage or a boiled sausage. The ingredients of a sausage may include:
ground meat from pork, poultry, fish, beef, or a combination hereof;
Garlic
Minced fat
Salt
Spices, usually white pepper
Various herbs
Optionally, vinegar and/or wine.

In an embodiment of the present invention, the food product, e.g. the pate or the sausage, may be supplemented with in the range of 5-75% (w/w) ingredient according to the present invention, such as in the range of 6-60% (w/w), such as in the range of 7-50% (w/w), e.g. in the range of 8-40% (w/w), such as in the range of 9-30% (w/w), e.g. in the range of 10-25% (w/w), such as in the range of 12-20% (w/w), e.g. in the range of 14-18% (w/w), such as in the range of 5-40% (w/w), e.g. in the range of 6-30% (w/w), such as in the range of 7-20% (w/w), e.g. in the range of 8-10% (w/w), The shelf life of the food product, e.g. the pate or the sausage, according to the present invention may be obtained at an elevated temperature, preferably the elevated temperature may be a temperature in the range of 10-45 °C, such as in the range of 15-40 °C, e.g. in the range of 17-35 °C, such as in the range of 18-30 °C, e.g. in the range of 19-28 °C, such as in the range of 20-25 °C, e.g. at about 22 °C.

In an embodiment of the present invention the improved shelf life of the food product, e.g. the pate or the sausage, according to the present invention may be obtained at an elevated temperature, relative to the shelf life of a corresponding food product without the fermented vegetable product (the ingredient).

A preferred embodiment of the present invention relates to a packaging comprising an ingredient for improving the shelf life of a food product, wherein the ingredient comprises a fermented vegetable material.

Preferably, the side of the packaging facing the food product may be supplemented with the ingredient according to the present invention.

In an embodiment of the present invention the packaging comprising the ingredient may be in contact with the food product or part of the food product.

In another embodiment of the present invention the packaging comprising the ingredient may not be in contact with the food product or part of the food product.

The packaging may be provided as wrapping paper, wrapping plastic, wrapping foil, plastic trays, organic trays, and the like.

It should be noted that embodiments and features described in the context of one of the aspects of the present invention or in the context of one embodiment of the present invention also apply to the other aspects and other embodiments of the invention.

The invention will now be described in further details in the following non-limiting examples.

### EXAMPLES

Example 1—Preparation of an ingredient according to the present invention 2 ingredients were prepared with two different starting materials (starting vegetable material) according to the present invention, one starting vegetable material was rapeseed and the other starting vegetable material was horse beans (Vicia faba).

About 80% starting material (rapeseed meal and Vicia faba meal, respectively) having an average diameter of about 2 mm, was mixed with about 14% wheat (source of phytase) 1% potato flakes (vegetable source), and 5% Perlac (carbohydrate source) in a fermentation tank. The moisture content was adjusted to about 40% humidity and a combination of the lactic acid-producing bacteria was added (the combination of bacteria included Pediococcus pentosaceus, Pediococcus acidilactici and Lactobacillus plantarum). The content of lactic acid bacterial added to the starting material amounted to about 2×10⁵ CFU/gram starting material.

The ingredients were mixed at room temperature and the temperature was slowly increased from the heat generated from the fermentation process to a steady state temperature of about 42 °C.

After 18 hours of fermentation the fermentation broth had a pH of 4.2 and a lactic acid concentration of about 140 mM. The fermented composition had a bacterial count of 3.6×10⁶ CFU/gram fermented vegetable material (ingredient). Analysing the ingredient showed only traces of acetic acid and ethanol were produced, hence the mixture was considered being 95-100% homofermentative.

The resulting fermented compositions (i) fermented rapeseed and (ii) fermented Vicia faba, was stored for application in various food applications.

### Example 2

Testing the shelf life of three food products with or without the ingredient of the present invention.

Two types of the ingredient were prepared. One with fermented rapeseed and one with fermented Vicia faba. Both products were obtained according to the procedure described in example 1.

Three food products are produced a rye bread, an organic chicken liver pate, and a pig liver pate.

Each food product was prepared in 3 portions, one which was un-supplemented, one supplemented with 10% fermented rapeseed and one supplemented with 10% fermented Vicia faba.

The products are stored with an open or broken packaging and a storage temperature of about 22 °C and shelf life was continuously inspected and analyse for aroma profiling as well as colour, smell and appearance.

In the table below, table 1, the following characters were given the food product
0: no activity
X: single mold stains and slight aroma change
XX: more than 30% covered with mould and spoiled odours
XXX: more than 70% covered with mold and very strong odor

The results

The results are presented in table 1 below:

| | Week | Week | Week | Weel |
|---|---|---|---|---|
| | 0-1 | 1-2 | 2-3 | 3-4 |
| Rye bread 10% FR | 0 | 0 | X | X |
| Rye bread 10% FB | 0 | 0 | X | XX |
| Rye bread 0% | 0 | X | XX | XXX |
| Org. Chick liver pate 10% FR | 0 | 0 | X | XX |
| Org. Chick liver pate 10% FB | 0 | X | XX | XXX |
| Org. Chick liver pate 0% | X | XX | XXX | XXX |
| Pig liver pate 10% FR | 0 | 0 | 0 | 0 |
| Pig liver pate 10% FB | 0 | 0 | X | X |
| Pig liver pate 0% | 0 | X | XX | XXX |

### Example 3

Testing the effect on shelf life of various food preparations including the ingredient according to the present invention.

### 2.1 Pork Pate

The basic pork pate was prepared from mixing the following ingredients to a pork pate dough:
100 grams unsalted butter,
100 grams minced onion,
1 kg ground pork,
20 slices bacon, finely chopped,
1 teaspoon salt,
1 teaspoon freshly ground black pepper
2 large eggs, lightly beaten

After the ingredients were mixed, the pork pate dough is divided into 9 substantially equal portions and subjected to 3 experiments, with each 3 replicates. The first experiment (3.1a) included 3 portions comprising the pork pate dough; the second experiment (3.1b) included 3 portions comprising the pork pate dough supplemented with 10% (w/w) fermented rapeseed from example 1, and the third experiment (3.1c) included 3 portions comprising the pork pate dough supplemented with 10% (w/w) fermented Vicia faba from example 1.

The 9 portions (from the 3 experiments) baked for 1 hour at 200 °C and left for cooling and stored with an open or broken packaging and a storage temperature of about 4 °C. The shelf life was evaluated based on regularly inspecting of the portions for bacterial and mold formation on the pork pate. After 25 days of incubation the experiment was terminated even though the food product was not yet spoiled, and the maximum shelf life was not yet reached.

The results are shown in table 1 below

### 3.2 Organic Chicken Liver Pate

The basic organic chicken liver pate was prepared from mixing the following ingredients to an organic chicken liver pate dough:
500 ml water,
1 kg blended (ground) chicken liver,
1 chopped onion,
250 ml melted butter,
¼ teaspoon salt,
¼ teaspoon ground black pepper,
⅛ teaspoon ground mace.

After the ingredients were mixed, the organic chicken liver pate dough is divided into 9 substantially equal portions and subjected to 3 experiments, with each 3 replicates. The first experiment (3.2a) included 3 portions comprising the organic chicken liver pate dough; the second experiment (3.2b) included 3 portions comprising the organic chicken liver pate dough supplemented with 10% (w/w) fermented rapeseed from example 1, and the third experiment (3.2c) included 3 portions comprising the organic chicken liver pate dough supplemented with 10% (w/w) fermented Vicia faba from example 1.

The 9 portions (from the 3 experiments) baked for 1 hour at 200 °C and left for cooling and stored with an open or broken packaging and a storage temperature of about 22 °C. The shelf life was evaluated based on regularly inspecting of the portions for bacterial and mold formation on the organic chicken liver pate.

The results are shown in table 1 below

### 2.3 Pork Liver Pate

The basic pork liver pate was prepared from mixing the following ingredients to a pork liver pate dough:
1 kg raw ground pig lever
400 g lard
500 grams minced onion,
5 dl milk
120 g wheat flour
2 teaspoon salt,
1 teaspoon freshly ground black pepper
3 large eggs, lightly beaten

After the ingredients were mixed, the pork liver pate dough is divided into 9 substantially equal portions and subjected to 3 experiments, with each 3 replicates. The first experiment (3.3a) included 3 portions comprising the pork liver pate dough; the second experiment (3.3b) included 3 portions comprising the pork liver pate dough supplemented with 10% (w/w) fermented rapeseed from example 1, and the third experiment (3.3c) included 3 portions comprising the pork liver pate dough supplemented with 10% (w/w) fermented Vicia faba from example 1.

The 9 portions (from the 3 experiments) baked for 1 hour at 200 °C and left for cooling and stored with an open or broken packaging and a storage temperature of about 22 °C. The shelf life was evaluated based on regularly inspecting of the portions for bacterial and mold formation on the pork pate. After 25 days of incubation the experiment was terminated even though the food product was not yet spoiled, and the maximum shelf life was not yet reached.

The results are shown in table 1 below

### 3.4 Pork Sausage

The basic pork sausage was prepared and stuffed into a natural sausage casing. The pork sausage was prepared from mixing the following ingredients to a pork sausage dough:
1 kg ground pork
300 g Pork Belly Fat
100 g Bread Crumbs
1 Tbsp Salt
1.5 Tbsp Ground Mace
1 Tsp Sweet Paprika
1 Tbsp Black Pepper

After the ingredients were mixed, the pork sausage dough is divided into 9 substantially equal portions and subjected to 3 experiments, with each 3 replicates. The first experiment (3.4a) included 3 portions comprising the pork sausage dough; the second experiment (3.4b) included 3 portions comprising the pork sausage dough supplemented with 10% (w/w) fermented rapeseed from example 1, and the third experiment (3.4c) included 3 portions comprising the pork sausage dough supplemented with 10% (w/w) fermented Vicia faba from example 1.

The 9 stuffed portions (from the 3 experiments) were left with an open or broken packaging and at a storage temperature of about 22 °C. The shelf life was evaluated based on regularly inspecting of the portions for bacterial and mold formation on the pork sausage.

The results are shown in table 1 below

### 3.5 Pork/Beef Salami

The basic pork/beef salami was prepared from mixing the following ingredients to a pork/beef salami dough:
500 g ground pork
500 g ground beef
150 g ground lard
1 Tbsp Salt
1 Tbsp Black Pepper
1 Tbsp sugar

After the ingredients were mixed, the pork/beef salami dough is divided into 9 substantially equal portions and subjected to 3 experiments, with each 3 replicates. The first experiment (3.5a) included 3 portions comprising the pork/beef salami dough; the second experiment (3.5b) included 3 portions comprising the pork/beef salami dough supplemented with 10% (w/w) fermented rapeseed from example 1, and the third experiment (3.5c) included 3 portions comprising the pork/beef salami dough supplemented with 10% (w/w) fermented Vicia faba from example 1. Alle the 9 portions were stuffed into a cellulose casing.

The 9 stuffed portions (from the 3 experiments) were salted at low temperatures and dried for 4 days. The dried portions are cured for 2 weeks.

The cured portions are left with an open or broken packaging and at a storage temperature of about 22 °C. The shelf life was evaluated based on regularly inspecting of the portions for bacterial and mold formation on the pork/beef salami. After 25 days of incubation the experiment was terminated even though the food product was not yet spoiled, and the maximum shelf life was not yet reached.

The results are shown in table 1 below

TABLE 1
Demonstrates the results as an average of the 3 replicates from
the various experiments with the different food products. The
shelf life is indicated in days until growth of microorganisms
are identified by visual inspection on the food product:

| | | (b) food product | (c) food product |
|---|---|---|---|
| | | supplemented | supplemented |
| | (a) non- | with 10% wt. | with 10% wt. |
| | supplemented | ingredient | ingredient |
| | food product | (Rapeseed) | (vicia faba) |
| 3.1 Pork pate | 20 | >25 | >25 |
| (4 °C) | | | |
| 3.2 Organic | 3 | 7 | 5 |
| chicken liver | | | |
| pate (22 °C) | | | |
| 3.3 Pork liver | 10 | >25 | 22 |
| pate (22 °C) | | | |
| 3.4 Pork sausage | 6 | 17 | 14 |
| (22 °C) | | | |
| 3.5 Pork/beef | 14 | >25 | >25 |
| salami (22 °C) | | | |

### CONCLUSION

The results show that an increased shelf life of the food products (the pork pate, the organic chicken liver pate, the pork liver pate, the pork sausage, and the pork/beef salami) may be significantly improved when adding an ingredient comprising a fermented vegetable material to a basic food component relative to a non-supplemented basic food component.

The results also show that using Brassica, in particular rapeseed, may be significantly better than using horse beans (Vicia faba).

The increased shelf life provided, by adding the ingredient comprising the fermented vegetable material, may also solve at least part of the challenge with and food waste. Furthermore, the experiment also demonstrates that long shelf life may be provided by adding the ingredient according to the present invention even at elevated storing temperature, at 22 °C as demonstrated in examples 3.2-3.5. Thus, the food product, when supplemented with the ingredient of the present invention, may be stored at room temperature without refrigeration/cooling and still have long shelf life.

The increased shelf life may also have a positive environmental effect due to reduced amount of energy, and thus emission of CO₂, used to refrigerate the food product and reduced amount of energy used for disposal of the food product as food waste.

1. Use of an ingredient for improving the shelf life of a food product, wherein the food product comprising a basic food component and the ingredient, and the food product comprises within the range of 5-75% (w/w) of the ingredient and wherein the ingredient comprises a fermented vegetable material, wherein the fermented vegetable material is not subjected to a yeast fermentation before being combined with the basic food component.

2. Use according to claim 1, wherein the basic food component is a meat product, a vegetable food product or a cereal product, a dairy product, a seafood product, or a combination hereof.

3. Use according to anyone of the preceding claims, wherein the fermented vegetable material is fermented using one or more lactic acid-producing microorganism.

4. Use according to anyone of the preceding claims, wherein the vegetable material is selected from a protein-rich vegetable material, and the protein-rich vegetable material is selected from a Brassicaceae family or a Fabaceae family, in particular the vegetable material comprises a Brassica species.

5. Use according to anyone of the preceding claims, wherein the content of ingredient in the food product is within the range of 6-60% (w/w), such as in the range of 7-50% (w/w), e.g. in the range of 8-40% (w/w), such as in the range of 9-30%.

6. Use according to anyone of the preceding claims, wherein the ingredient does not comprise reuterin (3-hydroxypropionaldehyde).

7. A food product comprising an improved shelf life, wherein the food product comprising a basic food component and an ingredient, and wherein the food product comprises in the range of 5-75% (w/w) of the ingredient and wherein the ingredient comprises a fermented vegetable material, wherein the fermented vegetable material has not been subjected to a yeast fermentation before being combined with the basic food component.

8. The food product according to claim 7, wherein the improved shelf life of is obtained at an elevated temperature relative to the shelf life of a corresponding food product at a refrigerated temperature.

9. The food product according to anyone of claims 7-8, wherein the basic food component is a meat product.

10. The food product according to anyone of claims 7-9, wherein the food product has a moisture content in the range of 10-75% (w/w).

11. The food product according to anyone of claims 7-10, wherein the content of ingredient in the food product is within the range of 6-60% (w/w), such as in the range of 7-50% (w/w), e.g. in the range of 8-40% (w/w), such as in the range of 9-30%.

12. The food product according to anyone of claims 7-11, wherein the ingredient does not comprise reuterin (3-hydroxypropionaldehyde).

13. The food product according to anyone of claims 7-12, wherein the fermented vegetable material consists essentially of a vegetable material and one or more lactic acid-producing microorganism.

14. The food product according to anyone of claims 7-13, wherein a fibrous material present in the vegetable material fermented is maintained or substantially maintained in the food product.

15. A food product comprising an improved shelf life, the food product comprising a basic food component and an ingredient, wherein the food product comprises in the range of 5-75% (w/w) of the ingredient and wherein the ingredient comprises a fermented vegetable material, and wherein the food product is selected from a meat product, a seafood product, a dairy product, or a combination hereof, wherein the fermented vegetable material is not subjected to a yeast fermentation before being combined with the basic food component.

16. A packaging comprising an ingredient for improving the shelf life of a food product, wherein the ingredient comprises a fermented vegetable material.
